(19) United States
(12) Patent Application Publication
(10) Pub. No.: US 2026/0264354 A1
(43) Pub. Date: Sep. 10, 2026

(54) FIRST DEFLECTION DEVICE, TIRE BUILDING PLANT AND METHOD

(71) Applicant: VMI HOLLAND B.V., Epe (NL)

(72) Inventors: Marcel SMITS, Epe (NL); Gerardus Johannes Catharina VAN LAAR, Epe (NL)

(21) Appl. No.: 19/167,474

(22) PCT Filed: Mar. 4, 2024
(86) PCT No.: PCT/NL2024/050099

§ 371 Date: Sep. 22, 2025

(30) Foreign Application Priority Data
Mar. 22, 2023 (NL) 2034395

(51) Int. Cl. B29D 30/44; B29D 30/38; B29D 30/42; B65H 57/14; B65H 57/16

(52) U.S. Cl. CPC B29D 30/44; B29D 30/42; B29D 2030/381; B29D 2030/4406; B29D 2030/4443; B65H 57/14; B65H 57/16; B65H 2801/93

(57) ABSTRACT

Please replace the Abstract in the application with the following Abstract, insert the following after the claims:

A first deflection device and method are provided for deflecting a first group of cords. The first deflection device comprises a deflection member for receiving the first group of cords in a receiving direction and for deflecting the first group of cords from the receiving direction to a deflection direction about a deflection axis. The deflection member is movable in a tensioning direction perpendicular to the deflection axis. A tire building plant and a method is also provided for manufacturing a cord-reinforced tire component.

### BACKGROUND

The invention relates to a first deflection device, a tire building plant and a method for manufacturing a cord reinforced tire component, for example a body ply or a breaker ply, for a green or unvulcanized tire.

FIG. 1 shows a known tire building plant comprising a tire manufacturing apparatus and two creels for alternatingly supplying cords to said tire manufacturing apparatus in a cord infeed direction. The creels are movable in a lateral direction perpendicular to the cord infeed direction between an active position in-line with the tire manufacturing apparatus and a standby position to the side of the creel that is in the active position, see also the dashed rectangle in FIG. 1 representing the standby position for the currently active creel.

### SUMMARY OF THE INVENTION

In response to an increasing market demand for tire components with a high number of embedded cords, the number of creel bobbins held by each creel is increased. A disadvantage of the known tire building plant is that the creels contribute considerably to the overall footprint of the known tire building plant. In particular, in the known in-line configuration of the creels, an increase in size of the creels significantly adds to the overall length of the known tire building plant. In other words, the known tire building plant consumes a lot of floor space.

It is an object of the present invention to provide a first deflection device, a tire building plant and a method for manufacturing a cord reinforced tire component, wherein cords can be organized more neatly.

According to a first aspect, the invention provides a first deflection device for deflecting a first group of cords, wherein the first deflection device comprises a deflection member for receiving the first group of cords in a receiving direction and for deflecting the first group of cords from the receiving direction to a deflection direction about a deflection axis, wherein the first deflection device further comprises an input cord collector for guiding the first group of cords in the receiving direction towards the deflection member and an input cord collector for guiding the first group of cords in the receiving direction towards the deflection member and an output cord collector for guiding the first group of cords in the deflection direction away from the deflection member, wherein the input cord collector defines a plurality of input guide positions which are mutually spaced apart with at least a vector component in a separation direction parallel to the deflection axis for threading each cord of the first group of cords through the input cord collector at a different input guide position of the plurality of input guide positions, wherein the input cord collector defines a plurality of input guide positions which are mutually spaced apart with at least a vector component in the separation direction for threading each cord of the first group of cords through the input cord collector at a different input guide position of the plurality of input guide positions, wherein the output cord collector defines a plurality of output guide positions which are mutually spaced apart with at least a vector component in the separation direction for threading each cord of the first group of cords through the output cord collector at a different output guide position of the plurality of output guide positions, wherein the first deflection device comprises a holder for holding the deflection member, wherein the deflection member is movable relative to the holder in a tensioning direction perpendicular to the deflection axis.

The cords can be deflected about the deflection axis from the receiving direction to the deflection direction while keeping the cords neatly organized, regardless of the mutual orientation in which the cords approach the input cord collector or the mutual orientation in which said cords leave the output cord collector. In particular, the cords can be reliably deflected, between the input cord collector and the output cord collector while preventing that the cords get entangled or twisted during said deflection. The deflection member can be moved back-and-forth in the tensioning direction, manually or automatically, into and out of contact with the cords. By moving the deflection member away from the cords, said cords can be threaded more easily through the respective cord collectors during the preparation and/or initial insertion of said cords. In particular, the cords may extend loosely through the area that is later occupied by the deflection member. Once all of the cords have been inserted, the deflection member can be moved back into position to put tension on said cords. Because every cord is threaded through the respective cord collectors at its own unique position, the movement, contact and/or tension between the deflection member and the cords can automatically detangle entangled or crossed cords.

Preferably, the input cord collector is configured for receiving the first group of cords in an input collection plane parallel to the receiving direction and the deflection axis and wherein the output cord collector is configured for receiving the second group of cords in an output collection plane parallel to the deflection direction and the deflection axis, wherein the deflection member is movable in the tensioning direction between an active position in which the deflection member is tangent to the input collection plane and/or the output collection plane and a retracted position in which the deflection member is spaced apart from the input collection plane and/or the output collection plane. Hence, the deflection member, in the active position, can be arranged so as to be tangent to the cords in the respective collection planes, thereby ensuring a smooth, reliable and/or controlled deflection of said cords around the deflection member.

In another embodiment the deflection member is a deflection roller that is rotatable about the deflection axis. The deflection roller can guide and/or feed the cords along its circumference with less friction compared to a stationary deflection member.

Preferably, each input guide position of the plurality of input guide positions is at a unique level along the separation direction with respect to the other input guide positions of the plurality of input guide positions.

Additionally or alternatively, each output guide position of the plurality of output guide positions is at a unique level along the separation direction with respect to the other output guide positions of the plurality of output guide positions.

In one embodiment the plurality of input guide positions are spaced apart in the separation direction over a first separation distance and the plurality of output guide positions are spaced apart in the separation direction over a second separation distance equal to the first separation distance. In other words, the cords can be kept parallel or substantially parallel during the deflection of the first group of cords about the deflection axis. Hence, it can be prevented that the cords get entangled or twisted during the deflection.

In another embodiment each input guide position of the plurality of input guide positions is level with an output guide position of the plurality of output guide positions in the separation direction. As a result, each cord can be deflected in a deflection plane perpendicular to the deflection axis. This can prevent twisting of the cord about its own longitudinal axis.

In another embodiment the input cord collector and the output cord collector are configured for guiding the cords of the first group of cords in a mutually parallel orientation to and from the deflection member, respectively. In other words, the distance between the cords can be kept constant during the deflection of the first group of cords about the deflection axis. Hence, it can be prevented that the cords get entangled or twisted during the deflection.

In a further embodiment the input cord collector comprises an input collector body and a plurality of input collection channels extending in the receiving direction through said input collector body for threading each cord of the first group of cords through a different first collection channel of the plurality of input collection channels in the receiving direction, wherein the output cord collector comprises an output collector body and a plurality of output collection channels extending in the deflection direction through said output collector body for threading each cord of the first group of cords through a different second collection channel of the plurality of output collection channels in the deflection direction. Each cord can be individually threaded through a respective one of the collection channels of the respective cord collectors, thereby preventing that the cords, at the respective cord collectors, get entangled or twisted.

In another embodiment the first deflection device is configured for deflecting the first group of cords between the receiving direction and the deflection direction over a deflection angle of at least twenty degrees, preferably at least forty degrees and most preferably at least eighty degrees. As mentioned before, such angles enable a whole new range of layout options for the tire building plant.

According to a second aspect, the invention provides a tire building plant comprising a tire manufacturing apparatus for manufacturing a cord reinforced tire component and a first creel for supplying cords to the tire manufacturing apparatus, wherein the tire building plant further comprises a first deflection device according to any one of the embodiments of the first aspect of the invention for receiving a first group of cords from the first creel and for deflecting said first group of cords in the deflection direction.

According to a third aspect, the invention provides a method for manufacturing a cord reinforced tire component using the tire building plant according to the second aspect of the invention, wherein the method comprises the steps of:
receiving the first group of cords at the first deflection device from the first creel;
threading each cord of the first group of cords through the input cord collector of the first deflection device in the receiving direction;
guiding each cord of the first group of cords from the input cord collector to the output cord collector of the first deflection device while deflecting the first group of cords at the first deflection device; and
threading each cord of the first group of cords through the output cord collector of the first deflection device in the deflection direction;
wherein the method further comprises the step of:
moving said deflection member in the tensioning direction.

The method relates to the practical implementation of the tire building plant according to the second aspect of the invention and thus has the same technical advantages, which will not be repeated hereafter.

Preferably, the input cord collector is configured for receiving the first group of cords in an input collection plane parallel to the receiving direction and the deflection axis wherein the deflection member of the first deflection device is movable in a tensioning direction between an active position in which the deflection member is tangent to the input collection plane and a retracted position in which the deflection member is spaced apart from the input collection plane, wherein the method further comprises the step of:
moving the deflection member from the active position into the retracted position; and
moving said deflection member from the retracted position into the active position.

In another embodiment the output cord collector is configured for receiving the second group of cords in an output collection plane parallel to the deflection direction and the deflection axis, wherein the deflection member of the first deflection device is movable in a tensioning direction between an active position in which the deflection member is tangent to the output collection plane and a retracted position in which the deflection member is spaced apart from the output collection plane, wherein the method further comprises the step of:
moving the deflection member from the active position into the retracted position; and
moving said deflection member from the retracted position into the active position.

According to a fourth, unclaimed aspect, the invention provides a tire building plant comprising a tire manufacturing apparatus for manufacturing a cord reinforced tire component and a first creel for supplying cords to the tire manufacturing apparatus, wherein the tire building plant further comprises a first deflection device for deflecting a first group of cords, wherein the first deflection device comprises a deflection member for receiving the first group of cords in a receiving direction and for deflecting the first group of cords from the receiving direction to a deflection direction about a deflection axis, wherein the first deflection device further comprises an output cord collector for guiding the first group of cords in the deflection direction away from the deflection member in an output collection plane parallel to the deflection axis and the deflection direction, wherein the output cord collector defines a plurality of output guide positions which are mutually spaced apart with at least a vector component in a separation direction parallel to the deflection axis (X) for threading each cord of the first group of cords through the output cord collector at a different output guide position of the plurality of output guide positions, wherein the tire manufacturing apparatus comprises a cord organizer for receiving the first group of cords from the first deflection device, wherein the cord organizer is configured for organizing the cords in an organizer plane transverse or perpendicular to the output collection plane, preferably wherein the lengths of the cords of the first group of cords downstream of the first deflection device undergo a tilt from the output collection plane to the organizer plane when leaving the first deflection device.

In other words, the deflection axis can be arranged in an orientation that is transverse or perpendicular to the organizer plane. The lengths of the cords of the first group of cords downstream of the first deflection device undergo a tilt from an output collection plane parallel to the deflection axis to the organizer plane when leaving the first deflection device. The output cord collector of the first deflection device can ensure that, despite of the tilt occurring in the first group of cords downstream of the first deflection device, the lengths of cords of the first group of cords between the deflection member and the output cord collector can be guided in the deflection direction about the deflection axis.

Moreover, by positioning the first deflection device in a position between a tire manufacturing apparatus and a creel in a tire building plant, said tire building plant does not necessarily need to have the creel in-line with the tire manufacturing apparatus. In fact, by providing the first deflection device, the creel can be positioned at any angle, including a sharp angle or a right angle, to the tire manufacturing apparatus, thereby enabling a whole new range of layout options. In this manner, the design of the layout is more flexible and can be adapted to best fit the available space in the factory. In particular, the overall length of the tire building plant can be reduced, more creels can be placed parallel to each other without adding to the width of the tire building plant and/or the tire building plant as a whole can be designed so as to be more compact.

In another embodiment the first creel comprises a frame for holding creel bobbins, wherein the frame of the first creel extends in a first creel plane that extends at a creel offset angle to the deflection direction of at least twenty degrees, preferably at least forty degrees and most preferably at least eighty degrees. As mentioned earlier, the first deflection device enables a whole new range of layouts for the tire building plant, including layouts features the creel offset angle as specified above.

In another embodiment the first creel is configured for supplying the first group of cords in multiple creel output directions converging towards the first deflection device. Hence, the lengths of the cords of the first group of cords upstream of the first deflection device approach and/or enter said first deflection device in various orientations. The input cord collector of the first deflection device can ensure that, despite of the various orientations of the cords upstream of the first deflection device, the lengths of cords of the first group of cords between the input cord collector and the deflection member are guided in the deflection direction at said input cord collector.

In another embodiment the tire building plant comprises one or more further creels similar to the first creel and one or more further deflection devices similar to the first deflection device, wherein each further deflection device is configured for receiving a further group of cords from a respective further creel of the one or more further creels and for deflecting said further group of cords. The one or more further creels can be positioned relative to the tire manufacturing apparatus in a similar orientation as the first creel, thereby enabling a whole new range of layouts for the tire building plant. It is noted that these new layouts can be made the subject of one or more divisional applications without the limitations of the deflection device.

Preferably, the first creel comprises a frame for holding creel bobbins, wherein the frame of the first creel extends in a first creel plane, wherein the one or more further creels comprises a second creel comprising a frame for holding creel bobbins, wherein the frame of the second creel extends in a second creel plane parallel or substantially parallel to the first creel plane. In other words, while the first creel and the second creel can be arranged at a creel angle to the deflection direction, they may still be arranged parallel to each other.

More preferably, the first creel plane and the second creel plane are spaced apart, in a lateral direction perpendicular to the first creel plane, over a spacing distance of less than one-hundred centimeters, preferably less than eighty centimeters and most preferably less than sixty centimeters. In the conventional layout of the known tire building plant according to the prior art, space is required around each creel to access the respective creel for servicing or refilling. However, as the tire building plant according to the present invention may feature a whole new range of layouts, in some of these layouts the spacing between the creels can be less or even non-existent. The ranges specified above may be insufficient for a human operator to enter the space between the creels. Reducing the spacing between the creels can lead to a more compact tire building plant.

In a further embodiment, that may also be applied independently to a group of creels, at least one creel of the first creel and the second creel is movable relative to the other of the first creel and the second creel in an exchange direction parallel to the first creel plane. Hence, instead of moving the creels laterally, as in the known tire building plant according to the prior art, the creels of the present invention may be moved in the exchange direction parallel to the first creel plane, thereby allowing one of the creels to be retracted relative to the other creels, for convenient accessing, servicing and/or refilling said retracted creel. In such a retractable configuration, there is no or little need for lateral spacing between the creels.

In a further embodiment, that may also be applied independently to a group of creels, the one or more further creels comprises a third creel comprising a frame for holding creel bobbins, wherein the frame of the third creel extends in a third creel plane parallel or substantially parallel to the first creel plane and the second creel plane, wherein the second creel is located between the first creel and the third creel in the lateral direction and movable relative to the first creel and the third creel in an exchange direction parallel to the first creel plane between a supply position in which the second creel is flush with the first creel and the third creel in the exchange direction and an exchange position in which the second creel is at least partially retracted relative to the first creel and the third creel in the exchange direction. In a similar way to the previously discussed embodiment, this embodiment allows for retracting the second creel from between the first creel and the third creel in the exchange direction, thereby eliminating the need for lateral spacing between the respective creels.

Alternatively, at least one creel of the first creel and the second creel is movable relative to the other of the first creel and the second creel in an exchange direction transverse or perpendicular to the first creel plane. Because of the deflection devices between the creels and the tire manufacturing device, multiple creels can be placed side-by-side in an orientation transverse or perpendicular to said tire manufacturing device. Moreover, the creels can be placed closer together, without any or only little lateral spacing, for example directly or almost directly adjacent to each other in the exchange direction, provided that the creels can move relative to each other in the exchange direction to create access space for servicing, maintenance and/or refilling.

In a further embodiment the first creel comprises a frame for holding creel bobbins, wherein the frame of the first creel extends in a first creel plane, wherein the one or more further creels comprises a fourth creel comprising a frame for holding creel bobbins, wherein the frame of the fourth creel extends in a fourth creel plane extending transverse or perpendicular to the first creel plane. Consequently, not all of the creels necessarily extend in the same orientation. A layout is envisioned in which creels or groups of creels may extend in different orientations, thereby allowing for alternatingly connecting the cords from different creels to the tire manufacturing apparatus, while the other creels are being serviced or refilled.

In a further embodiment the one or more further creels comprises a first group of creels and a second group of creels located on opposite sides of a central plane. Hence, the cords from the creels of one group can be conveniently connected to the tire manufacturing apparatus from one side of said central plane while the creels of the other group are being serviced and/or refilled.

Preferably, the tire manufacturing apparatus comprises a cord organizer for receiving the groups of cords from the first deflection device and the one or more further deflection devices, wherein the cord organizer is configured for organizing the groups of cords in a mutually parallel orientation in a cord infeed direction, wherein the central plane is parallel or substantially parallel to the cord infeed direction at the cord organizer. By aligning the central plane with the cord infeed direction, the cords can be fed from the first group of creels or the second group of creels towards the tire manufacturing apparatus in the same or substantially the same manner.

In another embodiment the tire building plant further comprises an automated exchange tool for automatically exchanging the creels. By automatically removing the creels from the group of creels at the tire building plant, the creels can be prepared, serviced and/or refilled in a remote location. Hence, less space is required at the tire building plant itself, allowing said tire building plant to be designed in a more compact manner. This may be particularly useful when the creels are relatively small, for example in a situation where multiple relatively small or short creels are placed side-by-side at the aforementioned creel angle to the deflection direction. These smaller creels are easier to handle and move around, for example using an automated guided vehicle (AGV) or an autonomous mobile robot (AMR).

According to a fifth, unclaimed aspect, the invention provides a method for manufacturing a cord reinforced tire component using the tire building plant according to the fourth, unclaimed aspect, of the invention, wherein the method comprises the steps of:
receiving the first group of cords at the first deflection device from the first creel;
deflecting the first group of cords at the first deflection device; and preferably;
tilting the lengths of the cords of the first group of cords downstream of the first deflection device from the output collection plane to the organizer plane when leaving the first deflection device.

In another embodiment the tire building plant comprises one or more further creels similar to the first creel and one or more further deflection devices similar to the first deflection device, wherein the method further comprises the steps of:
receiving a further group of cords at each further deflection device of the one or more further deflection devices; and
deflecting the further group of cords at the respective deflection device.

Preferably, the first creel comprises a frame for holding creel bobbins, wherein the frame of the first creel extends in a first creel plane, wherein the one or more further creels comprises a second creel comprising a frame for holding creel bobbins, wherein the frame of the second creel extends in a second creel plane, wherein the method comprises the step of:
positioning the first creel and the second creel such that the first creel plane and the second creel plane are parallel or substantially parallel.

More preferably, the method further comprises the step of:
moving at least one creel of the first creel and the second creel relative to the other of the first creel and the second creel in an exchange direction parallel to the first creel plane.

In another embodiment the one or more further creels comprises a third creel comprising a frame for holding creel bobbins, wherein the frame of the third creel extends in a third creel plane parallel to the first creel plane and the second creel plane, wherein the second creel is located between the first creel and the third creel in a lateral direction perpendicular to the first creel plane, wherein the method comprises the step of:
moving the second creel relative to the first creel and the third creel in an exchange direction parallel to the first creel plane between a supply position in which the second creel is flush with the first creel and the third creel in the exchange direction and an exchange position in which the second creel is at least partially retracted relative to the first creel and the third creel in the exchange direction.

Alternatively, the method further comprises the step of:
moving at least one creel of the first creel and the second creel relative to the other of the first creel and the second creel in an exchange direction transverse or perpendicular to the first creel plane.

In another embodiment the first creel comprises a frame for holding creel bobbins, wherein the frame of the first creel extends in a first creel plane, wherein the one or more further creels comprises a fourth creel comprising a frame for holding creel bobbins, wherein the frame of the fourth creel extends in a fourth creel plane, wherein the method comprises the step of:
positioning the first creel and the fourth creel such that the fourth creel plane extends transverse or perpendicular to the first creel plane.

In another embodiment the one or more further creels comprises a first group of creels and a second group of creels, wherein the method further comprises the step of:
positioning the first group of creels and the second group of creels on opposite sides of a central plane.

Preferably, the method further comprises the step of:
alternatingly connecting cords from the first group of creels and cords from the second group of creels to the tire manufacturing apparatus.

In another embodiment the tire building plant further comprises an automated exchange tool for automatically exchanging the creels.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a top view of a known tire building plant according to the prior art for manufacturing a cord reinforced tire component;

FIG. 2 shows a top view of a tire building plant according to a first exemplary embodiment of the invention for manufacturing a cord reinforced tire component;

FIG. 3 shows a top view of an alternative tire building plant according to a second exemplary embodiment of the invention for manufacturing a cord reinforced tire component;

FIG. 4 shows a top view of a further alternative tire building plant according to a fourth exemplary embodiment of the invention for manufacturing a cord reinforced tire component;

FIG. 5 shows a top view of a further alternative tire building plant according to a fifth exemplary embodiment of the invention for manufacturing a cord reinforced tire component;

FIG. 6 shows an isometric view of a first deflection device for use in any one of the tire building plants according to FIGS. 2-5

FIG. 7 shows a front view of an alternative input cord collector for use in the first deflection device of FIG. 6;

FIGS. 8A, 8B and 8C show top views of the first deflection device during steps of a method for manufacturing a cord reinforced tire component; and

FIGS. 9 and 10 show an isometric view and a top view, respectively, of a further alternative tire building plant according to a sixth exemplary embodiment of the invention.

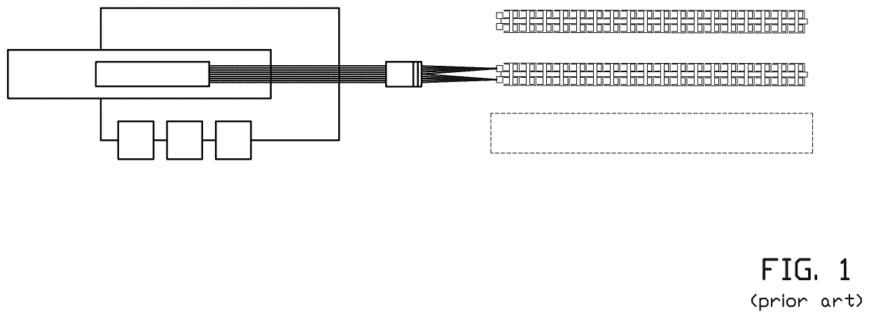

### DETAILED DESCRIPTION OF THE INVENTION

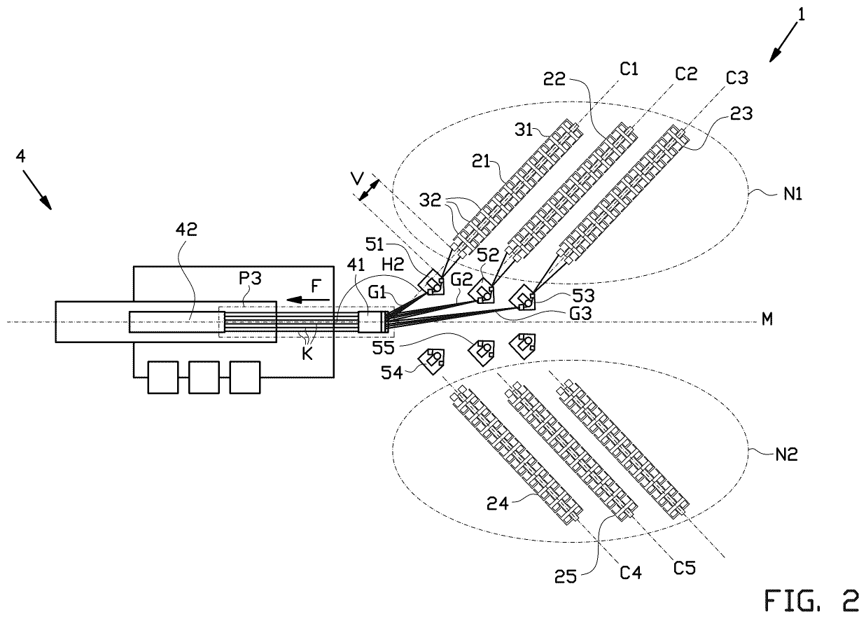

FIG. 2 shows a tire building line or tire building plant 1 according to a first exemplary embodiment of the invention. The tire building plant 1 comprises a tire manufacturing apparatus 4 for manufacturing a cord-reinforced tire component (not shown) and a plurality of creels 21-25 for supplying wires or cords K to the tire manufacturing apparatus 4. In this example, the cords K are metal cords, in particular steel cords. The cord-reinforced tire component may for example be a body ply or a breaker ply. Such a cord-reinforced tire component is used, together with other tire components, to form a green or unvulcanized tire.

As shown in FIG. 2, the tire manufacturing apparatus 4 comprises a cord organizer 41 for organizing the cords K received from the plurality of creels 21-25 and for guiding said cords K in an organized manner further into the tire manufacturing apparatus 4 in a cord infeed direction F. The tire manufacturing apparatus 4 further comprises an extruder 42 for receiving the cords K from the cord organizer 41 in the cord infeed direction F and for embedding said cords K in an extrudate of elastomeric material, in this example rubber, to form the cord-reinforced tire component.

As further shown in FIG. 2, the plurality of creels 21-25 comprises a first creel 21, a second creel 22, a third creel 23, a fourth creel 24 and a fifth creel 25. The fifth creel 25 is representative of any further creel, including the sixth creel which has not been assigned a reference numeral. It will be appreciated that, within the concept of the present invention, any number of creels may be combined in different layouts of the tire building plant. In this example, the plurality of creels 21-25 are divided into a first group N1 of creels 21-23 and a second group N2 of creels 24, 25.

The plurality of creels 21-25 will now be discussed in more detail with reference to the first creel 21 only. The first creel 21 is representative for any of the other creels 22-25.

The first creel 21 comprises a frame 31 for holding a plurality of creel reels or creel bobbins 32. Each creel bobbin 32 holds or carries a length of a cord K, wound in a plurality of windings around said creel bobbin 32. The frame 31 of the first creel 21 extends in or defines a first creel plane C1. Corresponding creel planes C2-C5 are defined for other creels 22-25.

In this example, the frame 31 of the first creel 21 supports or carries creel bobbins 31 on either side of the first creel plane C1. Alternatively, a creel may hold creel bobbins at one side of the respective creel plane only. In yet a further alternative embodiments, multiple creel bobbins may be supported concentrically or coaxially on the same side of the respective creel plane.

The cords K from the plurality of creel bobbins 32 are fed through the first creel 21 with the use of guides, such as guide tubes (not shown), and exit the first creel 21 at the front end thereof as first group G1 of cords K. The first group G1 of cords K2 is transferred from the first creel 21 towards the tire manufacturing apparatus 4 in a manner that will be discussed in more detail hereafter.

Similarly, a second group G2 of cords K exits the second creel 22 and a third group G3 of cords K exits the third creel 23. The cords K of the first group G1 of cords K, the cords K of the second group G2 of cords K and the cords K of the third group G3 of cords K are assembled and organized by the cord organizer 41 at the tire manufacturing apparatus 4. The cords, if any, in the creels 24, 25 of the second group N2 of creels 24, 25 are not yet prepared, fed and/or guide to the tire manufacturing apparatus 4.

As shown in FIG. 2, the tire building plant 1 further comprises a plurality of deflection devices 51-55 between the creels 21-25 and the tire manufacturing apparatus 4 for deflecting the groups G1-G3 of cords K from the creels 21-25 towards the tire manufacturing apparatus 4. In particular, the plurality of deflection devices 51-55 comprises a first deflection device 51 between the first creel 21 and the tire manufacturing apparatus 4, a second deflection device 52 between the second creel 22 and the tire manufacturing apparatus 4, a third deflection device 53 between the third creel 23 and the tire manufacturing apparatus 4, a fourth deflection device 54 between the fourth creel 24 and the tire manufacturing apparatus 4 and a fifth deflection device 55 between the fifth creel 25 and the tire manufacturing apparatus 4. The fifth deflection device 55 is representative of one of more further deflection devices, such as the sixth deflection device which has not been assigned a reference numeral.

The working principle of the plurality of deflection devices 51-55 will now be described in further detail with reference to the first deflection device 51 only. It will however be appreciated that the same working principle applies to each of the other deflection devices 52-55.

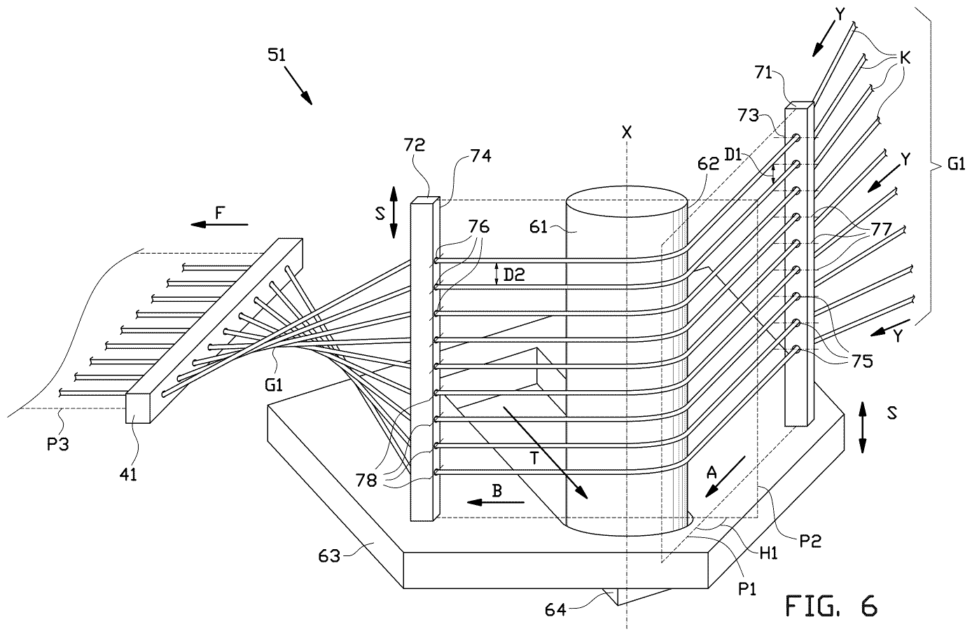

As shown in FIG. 6, the first deflection device 51 comprises a deflection member 61 for receiving the first group G1 of cords K in a receiving direction A and for deflecting the first group G1 of cords K from the receiving direction A to a deflection direction B about a deflection axis X. The cords K are deflected between the receiving direction A and the deflection direction B over a deflection angle H1 of at least twenty degrees, preferably at least forty degrees and most preferably at least eighty degrees. In this example, the deflection angle H1 is approximately ninety degrees.

In this example, the deflection axis X extends vertically or substantially vertically.

The deflection member 61 has a cylindrical and/or circumferential surface 62. The circumferential surface 62 is concentric to the deflection axis X. The circumferential surface 62 guides the cords K of the first group G1 of cords K along an arc or a circular section.

In the embodiment as shown in FIG. 6, the deflection member 61 is a deflection roller that is rotatable about the deflection axis X. The deflection member 61 may optionally comprise one or more circumferential grooves (not shown) for receiving the cords K of the first group G1 of cords K. More in particular, the deflection roller may comprises a plurality of individually and/or independently rotatable disc sections, each with a circumferential groove for receiving a respective cord K of the first group G1 of cords K.

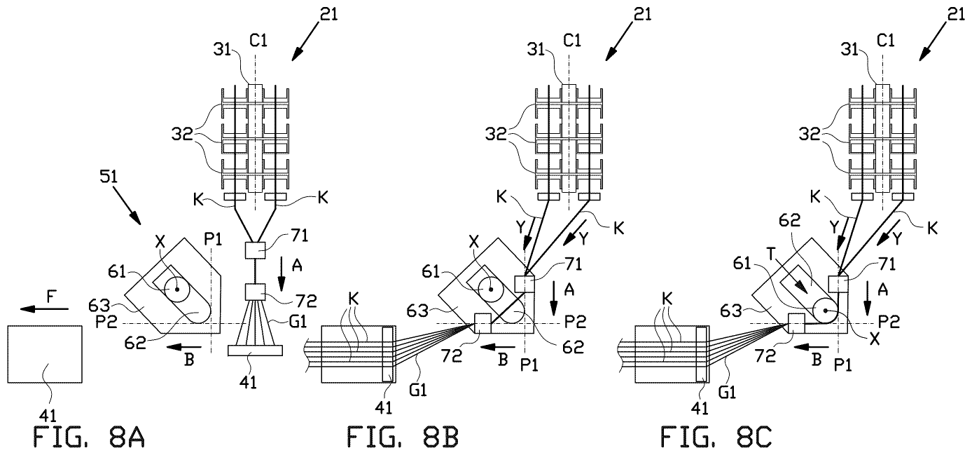

As best seen in FIG. 6, the first deflection device 51 further comprises a holder 63 for holding the deflection member 61. As shown in FIGS. 8B and 8C, the deflection member 61 is movable relative to the holder 63 in a tensioning direction T perpendicular to the deflection axis X. In this example, the holder 63 is formed as a platform or a plate-like member. In this example, as shown in FIG. 6, the first deflection device 51 comprises a tensioning drive 64 for driving the movement of the deflection member 61 relative to the holder 63 in the tensioning direction T.

As shown in FIG. 6, the first deflection device 51 is further provided with a first cord collector or an input cord collector 71 for guiding the first group G1 of cords K in the receiving direction A to the deflection member 61 and a second cord collector or an output cord collector 72 for guiding the first group G1 of cords K in the deflection direction B away from the deflection member 61. In particular, the input cord collector 71 collects the cords K from the first creel 21 and organizes or registers them in a first collection plane or an input collection plane P1 parallel to the deflection axis X and the receiving direction A. Similarly, the output cord collector 72 collects the cords K from the deflection member 61 and organizes or registers them in a second collection plane or an output collection plane P2 parallel to the deflection axis X and the deflection direction B. The input collection plane P1 and the output collection plane P2 extend at the deflection angle H1 to each other.

The input cord collector 71 and the output cord collector 72 are removable mounted to the holder 63 so as to enable preparation of the cords K remotely, in particular at the respective creel 21. In other words, the cord collectors 71, 72, optionally together with the cord organizer 41, may be moved into close proximity to the respective creels 21-25 to collect the cords K at the respective creels 21-25. Preferably, the cord collectors 71, 72 and the cord organizer 41 are assembled into a block, all aligned in a cord insertion direction, such that each cord K may conveniently be inserted in a single action through both cord collectors 71, 72 and the cord organizer 41. The cords K may subsequently be clamped, retained and/or fixed relative to the cord collectors 71, 72 and transferred, together with said cord collectors 71, 72, in an organized manner, towards the first deflection device 51.

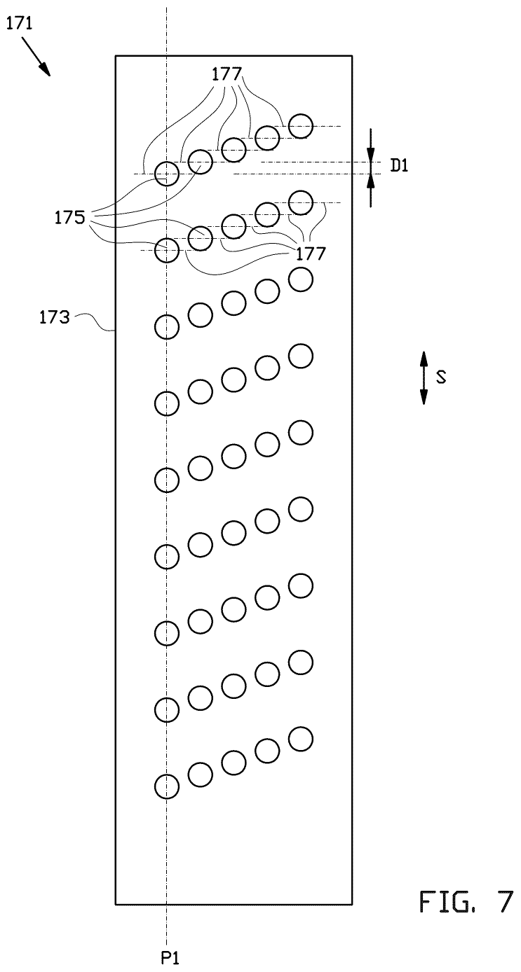

The previously discussed movement of the deflection member 61 in the tensioning direction T may take place between an active position, as shown in FIGS. 6 and 7C, in which the deflection member 61 is tangent to the input collection plane P1 and the output collection plane P2 and a retracted position, as shown in FIGS. 8A and 8B, in which the deflection member 61 is spaced apart from the input collection plane P1 and the output collection plane P.

As shown in FIG. 6, the input cord collector 71 and the output cord collector 72 are adapted, arranged or configured for guiding the cords K of the first group G1 of cords K to and from the deflection member 61, respectively. The input cord collector 71 defines a plurality of first guide positions or input guide positions 77 which are distributed over the input cord collector 71. In this example, the input guide positions 77 are arranged in a single row. The input guide positions 77 are mutually separated or spaced apart in or with at least a vector component in a separation direction S parallel to the deflection axis X for threading each cord K of the first group G1 of cords K through the input cord collector 71 at a different input guide position 77 of the plurality of input guide positions 77. In particular, each input guide position 77 of the plurality of input guide positions 77 is at a unique level along the separation direction S with respect to the other input guide positions 77 of the plurality of input guide positions 77. In other words, all of the input guide positions 77 are distributed over the input cord collector 71 in such a way that all of the input guide positions 77 are at their own, specific level, or height, in the separation direction s.

Similarly, the output cord collector 72 defines a plurality of output guide positions 78. The output guide positions 78 are also mutually spaced apart with at least a vector component in the separation direction S for threading each cord K of the first group G1 of cords K through the output cord collector 72 at a different output guide position 78 of the plurality of output guide positions 78. Again, each output guide position 78 of the plurality of output guide positions 78 is at a unique level along the separation direction S with respect to the other output guide positions 78 of the plurality of output guide positions 78.

Hence, the cords K can be reliably separated from each other at the respective cord collectors 71, 72 to prevent that they get entangled, twisted or crossed when passing the deflection member 6.

In this example, the input cord collector 71 comprises a first collector body or an input collector body 73 and a plurality of input collection channels 75 extending in the receiving direction A through said input collector body 73. The input collection channels 75 extend at and/or define the respective input guide positions 77. During preparation of the first creel 21 for connection to the tire manufacturing apparatus 4 in FIG. 2, each cord K of the first group G1 of cords K is threaded, usually manually, through a different first collection channel 75 of the plurality of first collection channels or input collection channels 75 in the receiving direction A. The input collection channels 75 extend through the input collector body 73 in the receiving direction A and/or parallel to the input collection plane P1.

Similarly, the output cord collector 72 comprises a second collector body or an output collector body 74 and a plurality of second collection channels or output collection channels 76 extending in the deflection direction B through said output collector body 74 for threading each cord K of the first group G1 of cords K through a different second collection channel 76 of the plurality of output collection channels 76 in the deflection direction B. The output collection channels 76 extend at and/or define the respective output guide positions 78. The output collection channels 76 extend through the output collector body 74 in the deflection direction B and/or parallel to the output collection plane P2.

As shown in FIG. 6, the plurality of input collection channels 75 are spaced apart in a separation direction S parallel to the input collection plane P1 and perpendicular to the receiving direction A over a first separation distance D1. The plurality of output collection channels 76 are spaced apart in the separation direction S over a second separation distance D2 equal or substantially equal to the first separation distance D1. In this example, the separation distances D1, D2 are equal for each pair of spaced apart collection channels 75, 76. Hence, the collection channels 75, 76 are evenly distributed over the respective cord collectors 71, 72 in the separation direction S.

In this particular example, each first collection channel 75 of the plurality of input collection channels 75 is at the same height as or level with a second collection channel 76 of the plurality of output collection channels 76 in the separation direction S. Consequently, the cords K can be threaded through the respective cord collectors 71, 72 while remaining in a mutually parallel orientation, i.e. without getting twisted, crossed and/or entangled.

As shown in FIG. 7, an alternative input cord collector 171 may be provided with a plurality of input collection channels 175 and/or a plurality of input guide positions 177 arranged in a plurality of rows and/or columns to form an array, a matrix or a grid of input collection channels 175 so that more cords K of the first group G1 of cords K can be threaded through the alternative input cord collector 171. Note that only the first row or column of input collection channels 175 extends in the input collection plane P1. The other input collection channels 175 may extend parallel to the input collection channels 175 in the input collection plane P1, or they may angled slightly with respect to the input collection plane P1. The input collection channels 175 are distributed over the alternative input cord collector 171 in such a way that, again, all input collection channels 175 and/or all input guide positions 177 are mutually separated and/or spaced apart in the separation direction S and/or that each first collection channel 175 and/or each input guide position 177 extends at its own unique level along the separation direction S.

It will be apparent that the first alternative cord collector 171 as shown in FIG. 7 may also be used to replace the output cord collector 72 in FIG. 6.

As further shown in FIG. 6, the first cord organizer 51 receives the cords K from the first creel 21 of FIG. 2 in multiple creel output directions Y converging towards the first deflection device 51. With the use of the input cord collector 71 the cords K can be neatly organized in the input collection plane P1, regardless of the multiple creel output directions Y.

Note that, because of the input cord collector 71, the first deflection device 51 can be positioned relatively close to its respective creel 21, even if this results in a relatively wide range of creel output directions Y converging towards the first deflection device 51. The distance between the first deflection device 51 and the first creel 21 is shown in FIG. 2 as a creel output distance V between the front end of the first creel 21 and the input cord collector of the first deflection device 51 in FIG. 2. Preferably, said creel output distance V is less than one-hundred-and-fifty centimeters, and more preferably over less than one-hundred centimeters.

Similarly, the cords K, once they leave the first deflection device 51 at the output cord collector 72, are transitioned from the output collection plane P2 towards and/or into the organizer plane P3, which in this example extends perpendicular to the output collection plane P2. Note that the twisting of the first group G1 of cords K in the area between the output cord collector 72 and the cord organizer 41 does not affect the organization and/or orientation of the same cords K in the first deflection device 51 between the input cord collector 71 and the output cord collector 72.

In FIG. 8B, the cords K of the first group G1 of cords K can be seen entering and leaving the first deflection device 51 at an oblique angle to the input collection plane P1 and the output collection plane P2, respectively. This oblique angle is exaggerated for the purpose of clarity in the drawings. It will however be understood that this oblique angle may be relatively small, e.g. only a few degrees, or even non-existent.

As the cords K are guided around the deflection member 51 in a mutually parallel orientation, the first group G1 of cords K can theoretically be deflected about any deflection angle H1 up to three-hundred-and-sixty degrees, without the risk of twisting, crossing over or entanglement of said cords K. Hence, the first deflection 51 and the other deflection devices 52-55 alike enable a whole new range of layouts for the tire building plant 1 according to the present invention, including, but not limited to the layouts shown in FIGS. 2-5.

In FIG. 2, the plurality of creels 21-25 are divided into a first group N1 of creels 21-23 and a second group of creels 23, 24 that may alternately or alternatingly be connected to the tire manufacturing apparatus 4. The groups N1, N2 of creels 21-25 are located, positioned and/or arranged on opposite sides of a central plane M. The central plane M is aligned with, in-line with and/or parallel to the cord infeed direction F of the tire manufacturing apparatus 4.

The creel planes C1-C5 of the creels 21-55 extend at an oblique creel offset angle H2 to the cord infeed direction F and/or the central plane M.

The creel planes C1, C2, C3 of the creels 21-23 of the first group N1 of creels 21-23 are mutually parallel. Similarly, the creel planes C4, C5 of the creels 24, 25 of the second group N2 of creels 24, 25 are mutually parallel. However, the creel planes C1, C2, C3 of the creels 21-23 of the first group N1 of creels 21-23 extend transverse or perpendicular to the creel planes C4, C5 of the creels 24, 25 of the second group N2 of creels 24, 25.

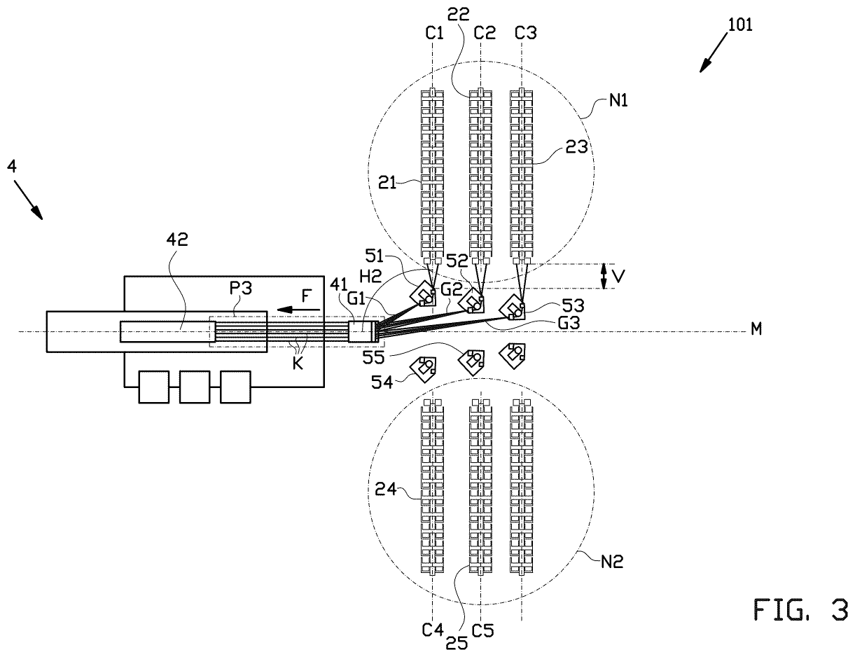

FIG. 3 shows an alternative tire building plant 101 according to a second exemplary embodiment of the invention, that differs from the previously discussed tire building plant 1 in that the creels 21-25 extend at a creel offset angle H2 of ninety degrees to the creel infeed direction F and/or the central plane M.

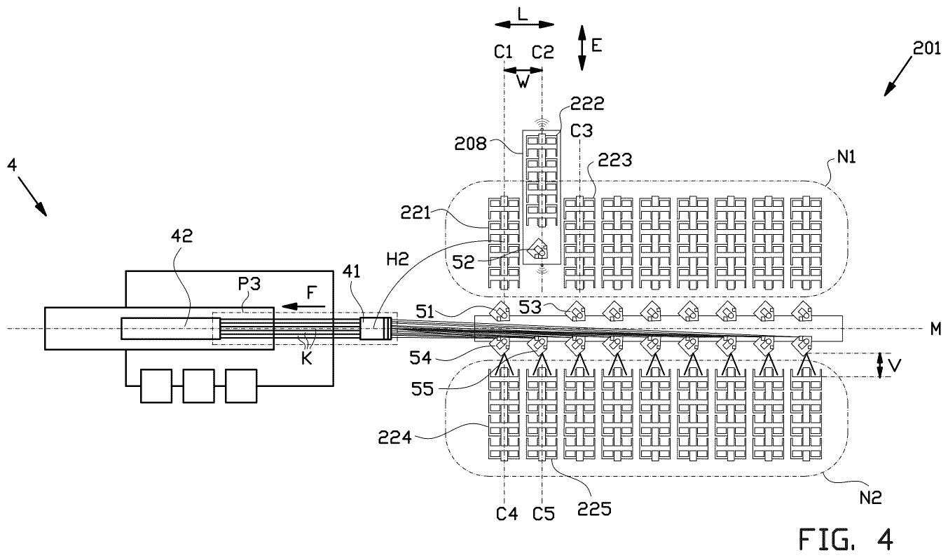

FIG. 4 shows a further alternative tire building plant 201 according to a third exemplary embodiment of the invention, that differs from the alternative tire building plant 101 in FIG. 3 in that its creels 221-225 are placed closer together. In particular, the first creel plane C1 and the second creel plane C2 are spaced apart, in a lateral direction L perpendicular to the first creel plane C1, over a spacing distance W of less than one-hundred centimeters, preferably less than eighty centimeters and most preferably less than sixty centimeters. The same spacing distance W may be applied to any other pair of adjacent creels 221-225.

Each creel 221-225 is movable relative to its directly adjacent creel(s) 221-225 in an exchange direction E parallel to its creel plane C1-C5. For example, the second creel 222 is movable relative to the first creel 221 and the third creel 223 in the exchange direction E. The second creel 222 is movable in said exchange direction E between a supply position in which the second creel 222 is flush with the first creel 221 and the third creel 223 and an exchange position, as shown in FIG. 4, in which the second creel 222 is at least partially retracted relative to the first creel 221 and the third creel 223 in the exchange direction E. In this way, at least a part of the second creel 222 is accessible for servicing and/or refilling. Alternatively, the second creel 222 may be replaced and/or interchanged with a replacement creel (not shown) in its entirety.

Note that the creels 221-225 in FIG. 4 are considerably shorter in a direction parallel to their respective creel planes C1-C5 compared to the creels 21-25 in the previously discussed embodiments. In particular, the creels 221-225 may only hold thirty creel bobbins or less, preferably twenty creel bobbins or less. Alternatively, the creels 221-225 may have a length parallel to their respective creel planes C1-C5 of less than four meters, preferably less than three meters. The creels 221-225 therefore have less capacity. This is compensated however by providing a greater number of creels in each group N1, N2, for example at least three, at least five or at least eight. Each creel 221-225 can be retracted in the manner as described above to exchange, service and/or refill the respective creel 221-225.

In particular, the layout of FIG. 4 allows for an automated extraction or exchange of one or more creels 221-225 with the use of automated exchange tools 208, such as robots or automated vehicles, in particular automatic guided vehicles (AGV) or autonomous mobile robots (AMR). The creels 221-225 may thus be removed from their respective groups N1, N2 to be services, refilled and/or prepared elsewhere, away from the active creels 221-225.

In FIG. 4, only one automated exchange tool 208 is shown by way of example. It will however be understood that each creel 221-225 may have its own automated exchange tool 208. Alternatively, one or more automated exchange tools 208 may be docked to and/or released from respective creels 221-225 and pick up any other creel 221-225.

Preferably, the creels 221-225 are exchanged together with the respective deflection device 51-55 such that the cords K may already be threaded through the cord collectors 71, 72 of the respective deflection device 51-55 when the respective creel 221-225 is still removed from its respective group N1, N2. Consequently, the creel 221-225 is already fully prepared for connection to the tire manufacturing apparatus 4.

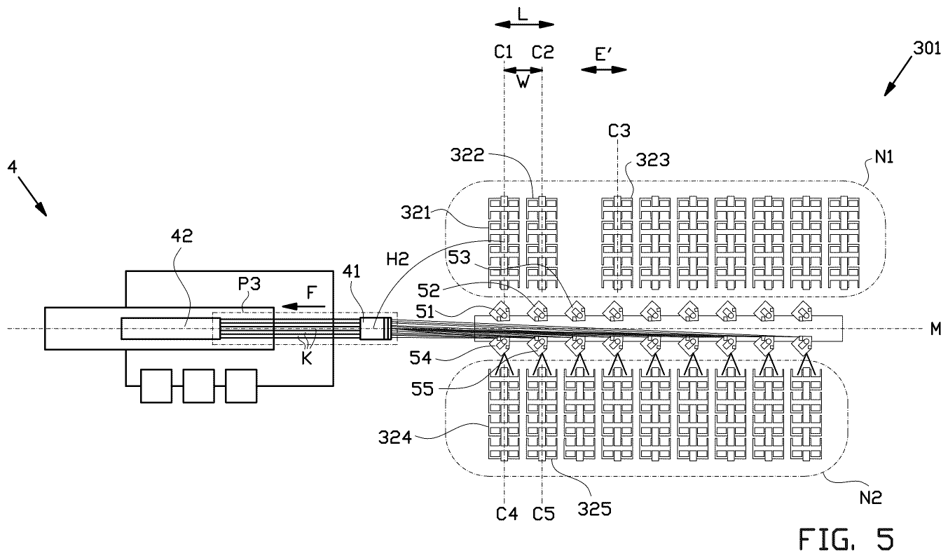

FIG. 5 shows a further alternative tire building plant 301 according to a third exemplary embodiment of the invention, that differs from the further alternative tire building plant 201 in FIG. 4 in that the creels 321-325 movable in an alternative exchange direction E′ parallel to the lateral direction L to create space for accessing the individual creels 321-325. In FIG. 5, all the creels 323 to the right of the second creel 322 are moved away from said second creel 322 in the alternative exchange direction E′ to create a walkway at the second creel 322.

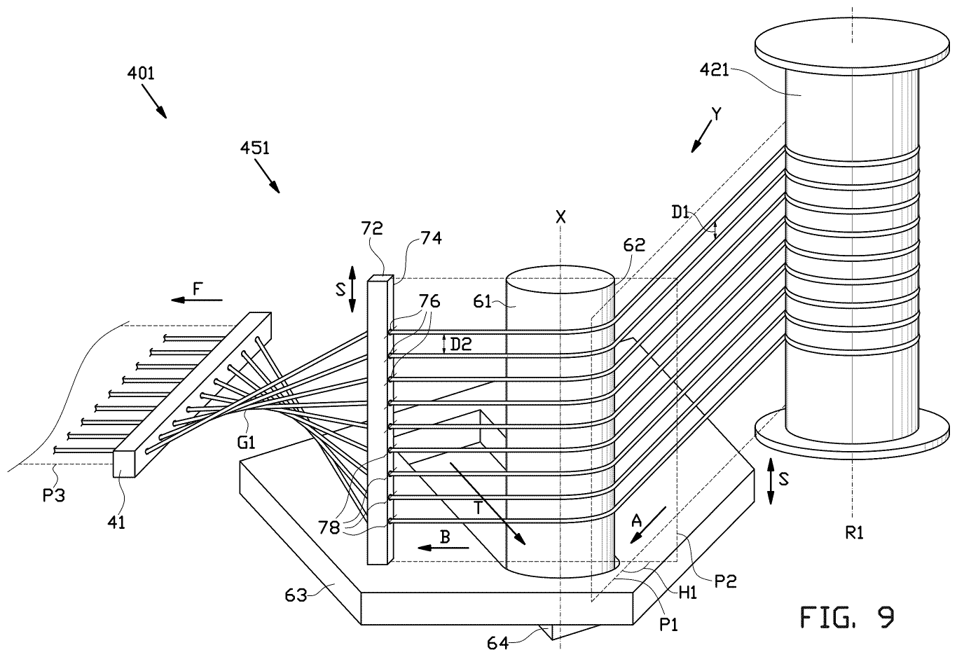

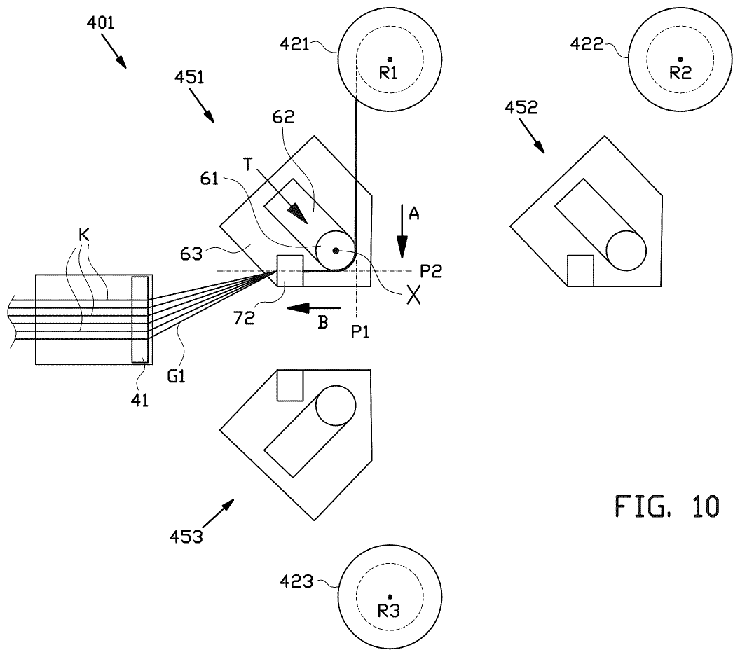

FIGS. 9 and 10 show a further alternative tire building plant 401 that differs from the previously discussed tire building plants 1, 101, 201, 301 in that the creels are replaced by stock reels 421, 422, 423. Each stock reel 421, 422, 423 holds a group of cords which may be unwound from the respective stock reel 421, 422, 423 towards the respective deflection device 451, 452, 453. The groups of cords may be wound on the stock reels 421, 422, 423 during a preparation phase at a creel, independently and/or at a separate location, long before the time that the groups of cords are required for embedding into the tire components during extrusion. In particular, multiple stock reels may be put in storage, for example in a warehouse, until they are required in the further alternative tire building plant 401.

Depending on the orientation of the stock reels 421, 422, 423, the first cord collector or input cord collector may not be required and/or optional. In particular, each stock reel 421, 422, 423 has a stock reel axis R1, R2, R3. For each stock reel 421, 422, 423 that has its stock reel axis R1, R2, R3 in an orientation that is parallel or substantially parallel to the input collection plane P1, in this example vertical or substantially vertical, the cords may be fed directly from the respective stock reel 421, 422, 423 to the deflection member 61. It will be appreciated that a first cord collector or input cord collector may still be used, for example in the event that the stock reel axes R1, R2, R3 have a different orientation transverse or perpendicular to the input collection plane P1, or even when the stock reel axis R1, R2, R3 is in the aforementioned orientation, thereby providing the same technical advantages as previously described in relation to the earlier embodiments.

In view of the above, the previously described creels 21-25, 221-225, 321-325 and the currently described stock reels 421, 422, 423 both have the function of supplying groups G1-G3 of cords K to the respective deflection devices 51-55, 451, 452, 453, and may therefore be rephrased throughout the application and the claims as ‘supply stations’.

A method for manufacturing the cord reinforced tire component using the any one of the previously discussed tire building plants 1, 101, 201, 301, 401 will now briefly be discussed with reference to FIGS. 8A, 8B and 8C.

FIG. 8A shows the situation in which the deflection member 61 is moved in the tensioning direction T into the retracted position. The first group G1 of cords K may now be received at the first deflection device 51 from the first creel 21.

The first group G1 of cords K may be threaded through the input cord collector 71 at the holder 63 of the first deflection device 51, or they may be threaded through the input cord collector 71 remotely from the holder 63 if the input cord collector 71 is removable from the holder 63. Similarly, the first group G1 of cords K may be threaded through the output cord collector 72 at the holder 63 of the first deflection device 51, or they may be threaded through said output cord collector 72 remotely from the holder 63 if the output cord collector 72 is removable from the holder 63. The cords K are may also already be guided towards and/or through the cord organizer 41 at or remotely from the first cord deflection device 51.

When all of the cords K are correctly positioned in the cord collectors 71, 72 and the cord organizer 41, the cords K are loosely guided along the deflection member 61 of the first deflection device 51. The deflection member 61 of the first deflection device 51 is then moved back in the tensioning direction T towards and/or into the active position of FIG. 8C, and/or into contact with the cords K. The cords K of the first group G1 of cords K are now deflected around the deflection member 61 of the first deflection device 51. The tension applied by the deflection member 61 onto the cords K can automatically detangle entangled or crossed cords K. Optionally, the deflection member 61 may be moved back and forth in the tensioning direction T repeatedly when the detangling is not successful at the first attempt.

The same process may be repeated at each further deflection device 52-55 of the plurality of deflection devices 51-55 in the respective tire building plants 1, 101, 201 of FIGS. 2-5.

The same process may be performed in a similar way and repeated for each stock reel 421, 422, 423 and for each deflection device 451, 452, 453 of the further alternative tire building plant 401 of FIGS. 9 and 10, optionally skipping the threading of the cords K through the input cord collector when such input cord collector is not included in the further alternative tire building plant 401.

The extruder 42 of the tire manufacturing apparatus 4 in FIG. 2 may subsequently be started up to start embedding the cords K in the extrudate, to form the cord-reinforced tire component.

As previously discussed, the creels 21-25, 221-225 may be arranged in the groups N1, N2 of creels 21-25, 221-225. Similarly, the stock reels 421, 422, 423 in FIGS. 9 and 10 may be arranged in a similar manner to the creels 21-25, 221-225. The cords K are then alternatingly connected from the first group N1 of creels 21-23, 221-223 or stock reels 421-423 and from the second group N2 of creels 24, 25, 224, 225 or stock reels 421-423 to the tire manufacturing apparatus 4. In the meantime, the creels 21-25, 221-225 or stock reels 421-423 of the inactive group N1, N2 of creels 21-25, 221-225 or stock reels 421-423 may be serviced, maintained, refilled, or in case of the tire building plants 202, 302 of FIG. 4 or 5, may be exchanged completely.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-37. (canceled)

38. A first deflection device for deflecting a first group of cords, the first deflection device comprises:
a deflection member for receiving the first group of cords in a receiving direction and for deflecting the first group of cords from the receiving direction to a deflection direction about a deflection axis;
an input cord collector for guiding the first group of cords in the receiving direction towards the deflection member; and
an output cord collector for guiding the first group of cords in the deflection direction away from the deflection member,
wherein the input cord collector defines a plurality of input guide positions which are mutually spaced apart with at least a vector component in a separation direction parallel to the deflection axis for threading each cord of the first group of cords through the input cord collector at a different input guide position of the plurality of input guide positions,
wherein the output cord collector defines a plurality of output guide positions which are mutually spaced apart with at least a vector component in the separation direction for threading each cord of the first group of cords through the output cord collector at a different output guide position of the plurality of output guide positions,
wherein the first deflection device further comprises a holder for holding the deflection member,
wherein the deflection member is movable relative to the holder in a tensioning direction perpendicular to the deflection axis.

39. The first deflection device according to claim 38, wherein the input cord collector is configured for receiving the first group of cords in an input collection plane parallel to the receiving direction,
wherein the deflection member is movable in the tensioning direction between an active position in which the deflection member is tangent to the input collection plane and a retracted position in which the deflection member is spaced apart from the input collection plane.

40. The first deflection device according to claim 38, wherein the output cord collector is configured for receiving the second group of cords in an output collection plane parallel to the deflection direction and the deflection axis,
wherein the deflection member is movable in the tensioning direction between an active position in which the deflection member is tangent to the output collection plane and a retracted position in which the deflection member is spaced apart from the output collection plane.

41. The first deflection device according to claim 38, wherein the deflection member is a deflection roller that is rotatable about the deflection axis.

42. The first deflection device according to claim 38, wherein each input guide position of the plurality of input guide positions is at a unique level along the separation direction with respect to the other input guide positions of the plurality of input guide positions.

43. The first deflection device according to claim 38, wherein each output guide position of the plurality of output guide positions is at a unique level along the separation direction with respect to the other output guide positions of the plurality of output guide positions.

44. The first deflection device according to claim 38, wherein the plurality of input guide positions are spaced apart in the separation direction over a first separation distance and the plurality of output guide positions are spaced apart in the separation direction over a second separation distance equal to the first separation distance.

45. The first deflection device according to claim 38, wherein each input guide position of the plurality of input guide positions is level with an output guide position of the plurality of output guide positions in the separation direction.

46. The first deflection device according to claim 38, wherein the input cord collector and the output cord collector are configured for guiding the cords of the first group of cords in a mutually parallel orientation to and from the deflection member, respectively.

47. The first deflection device according to claim 38, wherein the input cord collector comprises an input collector body and a plurality of input collection channels extending in the receiving direction through said input collector body for threading each cord of the first group of cords through a different first collection channel of the plurality of input collection channels in the receiving direction,
wherein the output cord collector comprises an output collector body and a plurality of output collection channels extending in the deflection direction through said output collector body for threading each cord of the first group of cords through a different second collection channel of the plurality of output collection channels in the deflection direction.

48. The first deflection device according to claim 38, wherein the first deflection device is configured for deflecting the first group of cords between the receiving direction and the deflection direction over a deflection angle of at least twenty degrees.

49. A tire building plant comprising a tire manufacturing apparatus for manufacturing a cord reinforced tire component and a first creel for supplying cords to the tire manufacturing apparatus,
wherein the tire building plant further comprises a first deflection device according to claim 38 for receiving a first group of cords from the first creel and for deflecting said first group of cords in the deflection direction.

50. A method for manufacturing a cord reinforced tire component using the tire building plant according to claim 49, wherein the method comprises the steps of:
receiving the first group of cords at the first deflection device from the first creel;
threading each cord of the first group of cords through the input cord collector of the first deflection device in the receiving direction;
guiding each cord of the first group of cords from the input cord collector to the output cord collector of the first deflection device while deflecting the first group of cords at the first deflection device;
threading each cord of the first group of cords through the output cord collector of the first deflection device in the deflection direction; and
moving said deflection member in the tensioning direction.

51. The method according to claim 50, wherein the input cord collector is configured for receiving the first group of cords in an input collection plane parallel to the receiving direction and the deflection axis,
wherein the deflection member of the first deflection device is movable in the tensioning direction between an active position in which the deflection member is tangent to the input collection plane and a retracted position in which the deflection member is spaced apart from the input collection plane,
wherein the method further comprises the step of:
moving the deflection member from the active position into the retracted position; and
moving said deflection member from the retracted position into the active position.

52. The method according to claim 50, wherein the output cord collector is configured for receiving the second group of cords in an output collection plane parallel to the deflection direction and the deflection axis,
wherein the deflection member of the first deflection device is movable in a tensioning direction between an active position in which the deflection member is tangent to the output collection plane and a retracted position in which the deflection member is spaced apart from the output collection plane,
wherein the method further comprises the step of:
moving the deflection member from the active position into the retracted position; and
moving said deflection member from the retracted position into the active position.
